(19) United States
(12) Patent Application Publication
(10) Pub. No.: US 2025/0169666 A1
(43) Pub. Date: May 29, 2025

(54) JOYSTICK CONTROLLED FAN SPEED CONTROL FOR LEAF VACUUM

(71) Applicants: Jeffrey J. Schwank, Sterling, IL (US); Jason K. Grimes, Ashton, IL (US)

(72) Inventors: Jeffrey J. Schwank, Sterling, IL (US); Jason K. Grimes, Ashton, IL (US)

(73) Assignee: Bonnell Industries, Inc., Dixon, IL (US)

(21) Appl. No.: 18/519,543

(22) Filed: Nov. 27, 2023

(51) Int. Cl. A47L 9/28; A47L 9/02; A47L 9/24; B60P 1/60; B60P 3/22

(52) U.S. Cl. CPC A47L 9/2889; A47L 9/02; A47L 9/24; A47L 9/2805; A47L 9/2842; A47L 9/2857; B60P 1/60; B60P 3/2245

(57) ABSTRACT

Systems and methods of debris collection are provided. The systems include an engine driving a vacuum generating fan and a collection hose that is configured to collect debris. A user interface having a safety interlock is provided to position the collection hose and to increase or decrease the speed of the engine. A controller operates to position the hose and control the speed based on the user input when the interlock is engaged. When disengaged, the controller stores the current operating speed and allows for continued manipulation of the hose for a period, after which the controller enters different timed stages of operation that limits further user input and decreases engine speed for more economical operation. When the interlock is again engaged, the controller returns to the stored engine speed and reenables operator control ensure efficient and economical operation without the need for any sensors in the debris removal system.

### FIELD OF THE INVENTION

This invention generally relates to debris removal vacuum systems and equipment, and more particularly to joystick user interface control of such debris removal vacuum systems and equipment.

### BACKGROUND OF THE INVENTION

At various times throughout the year, it becomes readily apparent that debris removal is important to maintain the health and well-being of a community. As an example, during the autumn of each year when the leaves change and fall, collection and removal of such leaves is necessary to maintain the aesthetics of neighborhoods, parks, roadways, etc. Moreover, collection and removal of leaves is necessary to maintain the safety of these various areas, particularly during periods of wet weather when the leaves become slippery on roadways and sidewalks, and adversely affect the ability to handle storm run off caused by the leaves clogging of sewer and drainage pipes. Additionally, if left to decay on their own, such wet leaves often develop mold and rob lawns and other plants of needed nutrients, and often smother and kill grass.

Absent municipal collection of such leaves, individual citizens often undertake their own collection and disposal of such leaves, often by burning. However, the combustion of leaves during windy periods increases the risk of fire spreading and damaging other property. Moreover, even if adequately contained, the burning of leaves results in smoke and airborne particles that often result in children with respiratory issues such as asthma having to be kept indoors for extended periods to avoid triggering an asthma attack. If not collected and properly disposed, wet leaves that become moldy may also trigger allergic sinusitis and other mold-related respiratory issues.

Responsible municipalities, contractors, golf courses, parks, etc., however, typically utilize industrial leaf vacuums in order to collect and remove such leaves to maintain a pleasant and healthy environment. Such leaf vacuums come in many forms, such as trailered units, hook lift units, as well as dedicated chassis mounted leaf vacuums.

Regardless of the form of the particular leaf vacuum, manufacturers thereof, such as the assignee of the instant application, design systems that are not only efficient in the collection and removal of such leaves, but also that consider operator comfort and operational safety. Indeed, such manufacturers balance these factors against environmental impact of the operation of the equipment itself, e.g., noise, exhaust, etc.

Specifically, modern leaf vacuums provide operator comfort by including features such as hydraulic boom control for carrying and moving the vacuum hose during collection operation. Such hydraulic boom control on modern leaf vacuum equipment often utilizes operator joystick control not only for movement of the control arm (boom) to move it up/down and left/right during the deployment, collection, and stowing operations, but also to provide control of the pickup nozzle sweep angle, vacuum fan throttle speed control, as well as control of accessory equipment such as turning a water pump on and off to aid in the collection operation if so equipped.

In systems that utilize such modern joystick control, the operational safety of the equipment may include a trigger that must be held by the operator, also known as a dead man switch, during the collection operation. If, for any reason, the trigger is released, the leaf vacuum equipment can immediately cease operation or transition to a failsafe mode of operation.

Unfortunately, the use of such trigger-based dead man switches often results in operator fatigue and discomfort from having to hold the trigger during extended periods of collection operation. As such, and against the strenuous warning from the manufacturers, operators have been known to tie off or otherwise defeat the dead man switch by affixing the trigger in a held position via zip ties, duct tape, etc. so that collection operation can continue without requiring the operator to hold the trigger closed. This results in defeat of the safety function for which the trigger was designed.

Modern leaf vacuum manufacturers have also recognized that while a high vacuum fan speed is necessary during the collection operation to adequately remove and mulch such leaves, particularly when such leaves are wet, such high-speed operation should only be used when necessary. That is, maintaining such high-speed fan operation between collection sites or while waiting for additional leaves to be provided for removal, adversely impacts the operating environment. This is because such high-speed operation utilizes more fuel than would otherwise be required during the periods when no leaves are being vacuumed. Further, such high-speed operation also generates more noise than idle operation, and can generate excessive dust when the leaves are particularly dry.

In order to reduce such environmental impacts during such periods between actual vacuuming of leaves, some manufacturers have deployed a series of sensors to detect various modes of operation and control the vacuum fan speed based thereon. For example, sensors have been added to detect whether the boom is stowed or deployed, whether there is debris or other material flowing in the collection hose, whether the collection container is filled or available to receive debris, etc. Through the use of such sensors, the vacuum fan speed can be controlled such that high-speed operation is only provided during periods of collection and is automatically throttled down when the collection is not occurring, when not possible, and when the collection hose is stored for transport.

Unfortunately, the inclusion of such sensors, as is often the case in any system, tends to increase the cost and complexity of such equipment. Such increase in cost and complexity often drives potential purchasers of such equipment to other less expensive, and possibly less environmentally friendly, options. Also as is often the case, the inclusion and use of multiple sensors also tends to reduce reliability of the equipment. Such reduction in reliability is often due to sensor failure, dirt or debris occluding or otherwise affecting the sensor operation, etc. Indeed, recognizing these common failure modes are often caused by dirt accumulation, many operators often bang on the equipment in an effort to dislodge dirt or debris that often is the cause of erroneous sensor operation. However, such solutions often result in more damage to the sensor and equipment in general, and therefore, often also drives potential purchasers to other, less complex, equipment.

In view of the above, what is needed is a new and improved leaf vacuum control system that provides operator comfort, operational safety, and environmentally responsible operation without the problems noted above with prior attempts to address these issues. Embodiments of the present invention provides such new and improved leaf vacuum equipment and methods of operation thereof. These and other advantages of the invention, as well as additional inventive features, will be apparent from the description of the invention provided herein.

### BRIEF SUMMARY OF THE INVENTION

Embodiments of the present invention provide a new and improved debris removal vacuum system and method of operation thereof that provides operator comfort, operational safety, and environmentally responsible operation. In systems requiring operator engagement of a safety interlock, e.g., a joystick trigger, certain embodiments provide continued operation of the collection and removal of debris, e.g., leaves, for certain periods after an operator releases the trigger before entering different operational stages to ensure such operator safety and environmental responsibility. In systems not requiring operator engagement of a safety interlock, certain embodiments provide continued operation of the collection and removal of debris, e.g., leaves, for certain periods after an operator no longer provides control input, e.g., speed, hose position adjustment, etc., before entering different operational stages.

In one embodiment, a debris removal vacuum system includes an engine operably coupled to drive a fan to generate a vacuum force, a control arm, a collection hose carried by the control arm and having a nozzle inlet configured to collect debris under the vacuum force generated by the fan. The system also includes in an embodiment a user interface configured to be manipulated by an operator to position the control arm and the collection hose carried thereby and to increase or decrease a speed of the engine to increase or decrease the vacuum force generated by the fan driven thereby. A safety interlock is also included in an embodiment.

In an embodiment, a controller operably connected to the user interface and the safety interlock is provided to receive a user input from the user interface to position the control arm and the collection hose carried thereby, a second user input from the user interface to increase or decrease the vacuum force generated by the fan driven by the engine, and a safety interlock engaged signal. Preferably, the controller is configured to effectuate positioning of the control arm and the collection hose carried thereby in accordance with the user input when the safety interlock engaged signal is received for embodiments having such a safety interlock, and to effectuate increasing or decreasing the vacuum force generated by the fan driven by the engine in accordance with the other user input.

In a preferred embodiment, the controller is configured to store an operating speed of the engine when it is determined that the operator is not actively present. By “actively present” it is meant either that the safety interlock signal indicates the safety interlock has been disengaged or that no user input from the user interface is detected. The controller also starts a first safety timer of a first safety duration during which the controller will continue to effectuate positioning of the control arm and the collection hose carried thereby in accordance with the first user input. After expiration of the first safety timer, the controller will no longer effectuate positioning of the control arm and the collection hose carried thereby regardless of the first user input. However, in an embodiment the controller is also configured to reset the first safety timer when the operator is again actively present, either because the safety interlock signal indicates the safety interlock has been reengaged or that a user input is again received during the first safety duration.

In a further embodiment the controller is configured to begin a second timer (an EcoMode timer) of a second duration, after expiration of the first duration in embodiments that include such a first timer, during which the controller will maintain the operating speed of the engine. In embodiments that do not include the first timer, the second timer will be started upon determination that the operator is not actively present, but otherwise operation is as just described. After expiration of the second timer, the controller will decrease the speed of the engine to an intermediate speed. However, in an embodiment the controller is configured to reset the second timer when the operator is determined again to be actively present during the second duration. In embodiments that include the first timer and that no longer effectuate positioning of the control arm upon expiration thereof, the controller of an embodiment will again effectuate positioning of the control arm and the collection hose carried thereby in accordance with the first user input.

In an additional embodiment the controller is configured to begin a third timer (a second EcoMode timer) of a third duration after expiration of the second duration during which the controller will maintain the intermediate speed of the engine. After expiration of the third timer, the controller will decrease the speed of the engine to a low idle speed. However, in an embodiment the controller is configured to reset the third timer when the operator is determined again to be actively present during the third duration. Thereafter, the controller of an embodiment will increase the engine speed to the operating speed. In embodiments that include the first timer and that no longer effectuate positioning of the control arm upon expiration thereof, the controller of an embodiment will then effectuate positioning of the control arm and the collection hose carried thereby in accordance with the first user input.

In one embodiment, the controller is further configured to turn off an accessory after the third duration. However, in an embodiment the controller is further configured to turn the accessory back on when the operator is determined again to be actively present. The controller will then increase the engine speed to the operating speed. In embodiments that include the first timer and that no longer effectuate positioning of the control arm upon expiration thereof, the controller of an embodiment will then effectuate positioning of the control arm and the collection hose carried thereby in accordance with the first user input.

In a preferred embodiment, the user interface is a joystick. Preferably, the safety interlock is a trigger integrated into the joystick. In other embodiments, the safety interlock utilizes capacitive touch integrated into the joystick to indicate user grip of the joystick. In yet other embodiments, the safety interlock utilizes an operator seat switch. In a further embodiment, the joystick includes a rocker switch to generate another user input, and wherein the controller is programmed to sweep the nozzle inlet upon receipt of such user input.

In one embodiment the joystick is configured to be positioned in at least two axes by an operator to generate the first user input and includes at least one button to generate the second user input. Preferably, the joystick includes a second button to generate a third user input. In such embodiment, the controller is programmed to reduce the engine speed upon receipt of the second user input and to increase the engine speed upon receipt of the third user input. In an embodiment the controller is programmed to maintain the engine speed at a current level upon loss of one of the second user input or the third user input. In another embodiment the controller is programmed to return the engine speed to an operating speed upon loss of one of the second user input or the third user input.

In an embodiment of the present invention, a method of controlling a debris removal vacuum system includes the steps of storing an operating speed of the engine when the operator is determined not to be actively present. In certain embodiments, the method then begins a first timer of a first duration. During the first duration, the method includes the steps of positioning a collection hose under user control and resetting the first timer when the operator is determined again to be actively present. After the first duration, the method includes the steps of prohibiting positioning of the collection hose under user control and beginning a second timer of a second duration. In embodiments that do not include the first timer, the step of beginning a second timer occurs when the operator is determined not to be actively present. In either embodiment, during the second duration the method includes the step of maintaining an operating speed of the engine, and after the second duration decreasing the speed of the engine to an intermediate speed.

In an embodiment, the method also includes the steps of, during the second duration, resetting the second timer when the operator is determined again to be actively present. Thereafter, in embodiments that prohibited positioning of the collection hose after the first duration, positioning a collection hose under user control. In one embodiment after the second duration, the method includes the step of beginning a third timer of a third duration. During the third duration the method maintains the intermediate speed of the engine, and after the third duration, decreases the speed of the engine to a low idle speed. Preferably, the method further includes the steps of, during the third duration, resetting the third timer when the operator is determined again to be actively present and increasing the engine speed to the operating speed. In embodiments that include the first timer and that no longer effectuate positioning of the control arm upon expiration thereof, also positioning a collection hose under user control.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric illustration of an embodiment of a debris removal vacuum system, particularly well-suited to leaf removal, constructed and operated in accordance with the teachings of the present invention;

FIG. 2 is an isometric illustration of an additional embodiment of a debris removal vacuum system, also particularly well-suited to leaf removal, constructed and operated in accordance with the teachings of the present invention;

FIG. 3 is an isometric illustration of an embodiment of an operator control interface for use in embodiments of the debris removal vacuum systems constructed and operated in accordance with the teachings of the present invention;

FIG. 4 is an isometric illustration of an embodiment of a joystick for use in an embodiment of an operator control interface in embodiments of the debris removal vacuum systems of the present invention constructed and operated in accordance with the teachings of the present invention;

FIG. 5 is a control flow diagram illustrating an embodiment of a method of operating a debris removal vacuum system that reduces operator fatigue while ensuring operator safety and economical and efficient operation of embodiments of the debris removal vacuum system constructed and operated in accordance with the teachings of the present invention; and

FIG. 6 is a simplified control block diagram of an embodiment of an operator control interface constructed and operated in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, there are illustrated embodiments of the present invention that provide safe and effective debris removal, e.g., leaf vacuums equipment, and methods of performing same. It should be noted, however, that such embodiments are provided by way of example, and not by way of limitation, and that the novel features of the present invention may find applicability in other operating environments and configurations that many benefit from the features and operating modes discussed in the following description. All rights to such alternative embodiments are reserved.

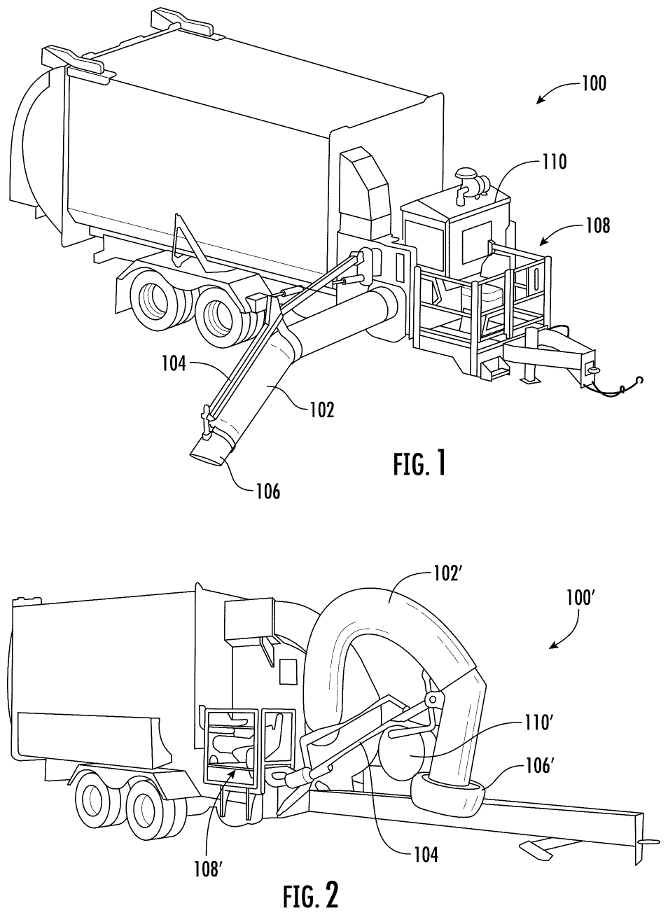

Turning specifically to FIG. 1, there is illustrated a debris removal vacuum system 100 constructed and operated in accordance with embodiments of the present invention. Similarly, FIG. 2 illustrates a different embodiment of a debris removal vacuum system 100′ that utilizing a slightly different physical configuration but that is operated in accordance with embodiments of the control method described herein. While each of FIG. 1 and FIG. 2 illustrates trailered units, other embodiments of the present invention may be embodied as hook lift leaf vacuum units, dedicated chassis mounted leaf vacuum units, etc.

Regardless of the particular configuration of the debris removal vacuum system 100, each typically includes a collection hose 102 that may be positioned by a control arm 104. This control arm 104 is typically hydraulically positioned, although the positioning mechanism is not limited thereto and may utilize electrical, pneumatic, etc. actuators known in the art to position the control arm 104 and attached collection hose 102 under operator control. Indeed, such operator control may utilize numerous control axes depending on the complexity of the particular system in order to position the collector hose 102 and its collection nozzle 106 to perform the collection operation in an efficient and effective manner.

To ensure safe and effective control and positioning of the collection hose 102 and its collection nozzle 106 during the collection operation, an operator cockpit 108 is provided on the debris removal vacuum system 100 at a location to ensure visibility of the operating environment and the collection hose 102 and its collection nozzle 106. Such operator cockpit 108 may be generally open with appropriate safety bars positioned to prevent injury of the operator. In other embodiments of the present invention the operator cockpit 108 may be enclosed by an operator cab, such as those described in co-pending U.S. patent application Ser. No. 29/879,071, entitled Operator Cab on Trailer, and assigned to the assignee of the present application, the teachings and disclosure of which are hereby incorporated in their entireties by reference thereto.

In addition to controlling the positioning of the collection hose 102 and its collection nozzle 106, the operator is also typically provided with control mechanisms for the debris removal vacuum system 100 engine 110 so as to control the speed of the fan (not shown) driven thereby to generate the vacuum force and mulching action of the debris removal vacuum system 100. As used herein, “engine” refers to the device or devices that provide motive power to rotate or operate the fan, the movement of which generates the vacuum force used to remove the debris. Such “engines” should be understood to include dedicated or shared liquid or gaseous fuel driven combustion engines and associated gearing and couplings, hydrostatic drives, electric motors and associated controls, pneumatic motors, hydraulic motors, hybrid motors, and combinations of same. Indeed, controlling of the “engine speed” is used herein to describe control of the speed of the driven fan to control, e.g., the vacuum force generated thereby. Depending on the configuration and accessories included therewith, the operator may also be provided with control of such accessories from the operator cockpit 108, e.g., water pump, lights, etc.

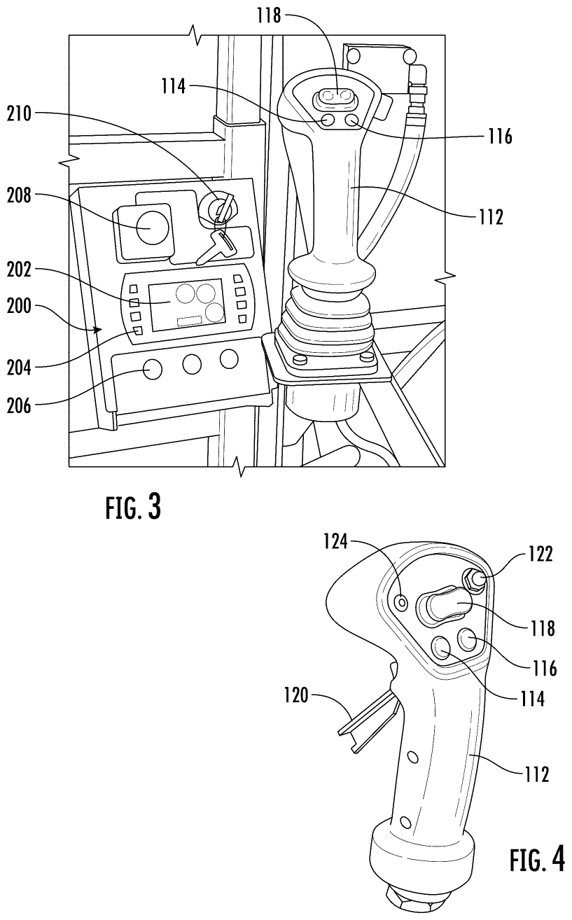

Turning to FIG. 3, such control inputs that are accessible by the operator and information displayed to the operator are illustrated. The system controller 200 typically includes such a system display 202, although the display 202 may be provided by a dedicated display driven by an external or remotely located controller. In the illustrated embodiment, the controller 200 includes programmable soft keys 204 to provide differing control inputs depending on current operating mode, hard keys 206 having dedicated function control, an emergency stop button 208, an ignition key input 210, etc., the operation and function of which are well known by those skilled in the vacuum leaf removal equipment art.

The control input from the operator for the positioning of the control arm 104 and the attached collection hose 102 and collection nozzle 106 is provided in certain embodiments of the present invention via a joystick 112 also shown in FIG. 4. Such joystick 112 may be manipulated by the user by pushing the entire joystick 112 forward, pulling the joystick 112 back, or moving the joystick 112 to the left or right sides by movement of the operator's arm and hand in a known manner. Such positional manipulation of the joystick 112 is communicated to the controller 200 in a known manner.

In certain embodiments, other operator control inputs, such as control buttons 114, 116 or switches, such as rocker switch 118, may also be provided on the joystick 112. When such buttons 114, 116 and switch 118 are provided, the operator is able to utilize individual fingers, typically the thumb, to provide additional input for control of the debris removal vacuum system 100. The provision of both hand and thumb control through the joystick 112 allows efficient control the various functions and components of the debris removal vacuum system 100. Manipulation of such joystick-mounted control buttons and switches is also communicated to the controller 200 in a known manner.

In one embodiment of the present invention, both engine speed control and control arm operation are provided through this user interface, and energy efficient operation thereof is provided automatically as will be discussed more fully below. Specifically, in this embodiment the engine speed controls are provided by the control buttons 114, 116 under control of the operator, and will ensure efficient and economical operation thereof without the need for any sensors in the debris removal vacuum system 100. That is, no sensor to indicate the presence, absence, or amount of material in the conduit, no sensor to indicate whether the boom is in the stowed position or the operating position, no sensor to indicate the condition of the material collection container, etc. are required to enable energy efficient operation of the debris removal vacuum system 100 of the present invention.

For example, control button 114 may be used to decrease the engine speed, while control button 116 may be used to increase it. That is, if the operator were to press and hold control button 114, the engine speed will be decreased. When the desired speed is achieved, the operator simply releases control button 114. Similarly, if the operator were to press and hold control button 116, the engine speed would be increased. Once the desired engine speed is achieved, the operator need only release the control button 116. In one embodiment, the engine speed is held at a constant speed at the level achieved at the time the control button 114, 116 is released. Such an embodiment reduces operator fatigue by only requiring that the operator depressed one of the control buttons 114, 116 in order to increase or decrease the engine speed instead of requiring a button be held depressed, e.g. during extended periods of collection.

In an alternative embodiment, the control buttons 114, 116 may be used to temporarily decrease or increase the engine speed from a predetermined or preset engine speed setpoint. In such an embodiment, the engine operates at a predetermined speed until and unless the operator depresses one of control button 114 or 116. While held in the depressed position, the engine speed will either decrease or increase, respectively. Such operation allows the operator to reduce the vacuum pressure, fuel consumption, and noise while moving between collection points, or to increase the vacuum suction power temporarily to aid in collection of, e.g., wet leaves or more compacted debris. In this embodiment, once the control button 114 or 116 is released, the engine speed will then automatically return to the preset or predetermined engine speed.

Movement of the control arm 104, and therefore the positioning of the collection hose 102 and the collection nozzle 106 (see FIGS. 1, 2), is provided in one embodiment by movement of the joystick 112 itself, and operation of the rocker switch 118, respectively. In such embodiment, the control arm 104 is raised by the operator pulling back on the joystick 112 towards the operator. The control arm 104 may be lowered when the joystick 112 is pushed away from the operator. Moving the joystick 112 to the left results in the control arm 104 being swung to the left, while movement of the joystick 112 to the right will result in the control arm 104 being swung to the right. In embodiments that include control of the collection nozzle 106, the sweep angle of the collection nozzle 106 may be changed by moving the rocker switch 118 to the left or right.

In an embodiment of the present invention, engine speed may be increased or decreased by single operation of control button 114, 116, respectively. However, in order to ensure operator and worker safety and to prevent movement of the control arm 104 by accidental movement of the joystick 112, enabling such movements also requires that a safety interlock, e.g., the trigger 120 shown in FIG. 4 (hidden in the view of FIG. 3), be satisfied, e.g., depressed. That is, in this embodiment, the trigger 120 of the joystick 112 must be actuated in order to allow movement of the joystick 112 to reposition the control arm 104. Further, in an embodiment the trigger 120 must also be actuated in order to sweep the collection nozzle 106.

In such an embodiment, the chance of inadvertent movement of the large control arm 104 and the collection hose 102 is minimized so as to minimize the potential for unintended contact with other workers or surrounding structures. In other words, in an embodiment the operator must depress the trigger 120 and pull the joystick 112 toward the operator in order to raise the control arm 104, must depress the trigger 120 and push the joystick 112 away from the operator in order to lower the control arm 104, must depress the trigger 120 and move the joystick 112 to the operator's left to move the control arm 104 left, must depress the trigger 120 and move the joystick 112 to the operator's right to move the control arm 104 to the right, and must depress the trigger 120 and move the thumb control provided by rocker switch 118 left or right in order to sweep the angle of the collection nozzle 106.

In alternative embodiments, such safety feature or interlock may be provided by operator presence indicators, such as a seat pressure switch, seat belt latch, capacitive touch, proximity sensor, motion detector, radar speed detector, ultrasonic detector, etc. Such detectors may be integrated into the control to prevent movement of the control arm 104 and/or collection nozzle 106 caused by inadvertent movement of the joystick 112 when the operator is not in the cockpit 108, seated and secured. The capacitive touch sensing, similar to that used in smartphone touch screens, may be integrated in the joystick 112 to ensure that any movements thereof are the result of operation manipulation.

In embodiments that include accessory components, such as a water pump, and accessory control button 122 and indicator light 124 may be included. Depending on the function of the accessory component, operation thereof may be enabled by simply actuation of the accessory control button 122, e.g., in the case of a supplied water pump, without requiring any safety interlock, such as provided by the trigger 120. However, if operation of the accessory may provide any safety concern regarding inadvertent operation thereof, then the operator will be required to operate the safety interlock, e.g., via actuation of the trigger 120, in order for actuation of the accessory control button 122 to activate the accessory component in such embodiment.

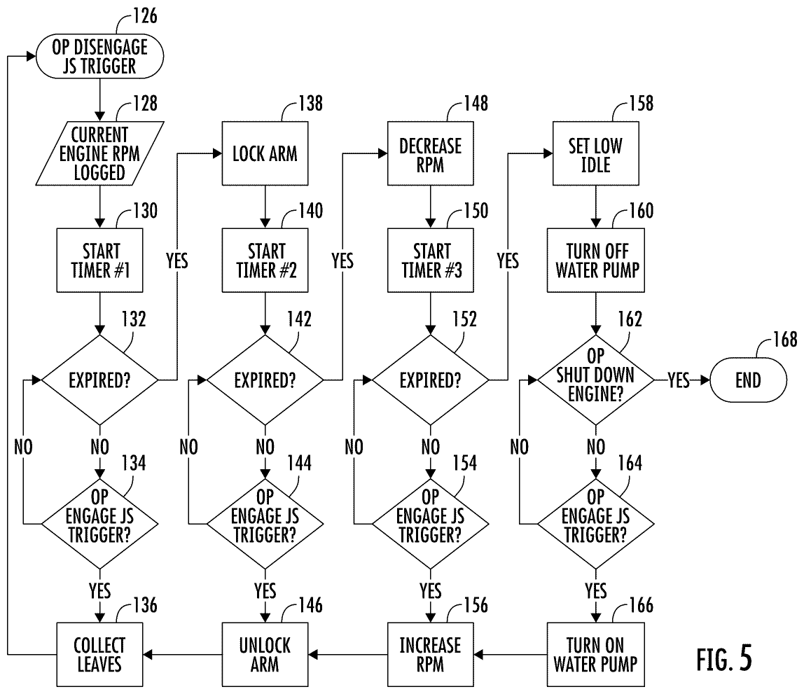

As discussed above, while such trigger 120 usage ensures safety, fatigue often drives operators to bypass this trigger 120 safety. To prevent such fatigue while ensuring safe, efficient, and economical operation, without the need for the addition of sensors, embodiments of the present invention utilize the operational control method as illustrated in the flow diagram of FIG. 5 based upon a determination that the operator is actively present or not. That is, no sensor to indicate the presence, absence, or amount of material in the conduit, no sensor to indicate whether the boom is in the stowed position or the operating position, no sensor to indicate the condition of the material collection container, etc., are required to enable safe, energy efficient operation of the debris removal vacuum system 100 of the present invention based on the programming of the controller 200 in accordance with the flow diagram of FIG. 5.

Specifically, this safe, energy efficient operation allows for the operator not to be actively present continuously, e.g., allows disengagement of the trigger 120 and/or a lack of user inputs for certain predefined or adjustable periods during different phases of operation while ensuring operator and worker safety and operational efficiency. In other words, in various embodiments and during different phases of operation, the operator is able, e.g., to release the trigger 120 or not adjust any operating parameter while still performing the operation for certain periods. Thereafter, the system will move to more efficient modes of operation, in stages or otherwise, if the operator is determined not to be actively present, e.g., if trigger 120 is not reengaged by the operator. Once the operator is again determined to be actively present, e.g., by trigger 120 being reengaged by the operator or providing a user input, however, the collection operation may again be returned to the mode set by the operator, e.g. at the engine speed set via control buttons 114, 116.

Specifically, when the operator is determined not to be actively present, e.g., when the operator disengages the joystick trigger and is not providing any user input, at step 126, the current engine speed is logged in memory at step 128 and a first timer is started at step 130. This timer is preferably set to between 0 and 30 seconds, and in a preferred embodiment is set at 5 seconds. However, other periods may be utilized depending on the particular configuration of the debris removal vacuum system 100 or other system in which this control methodology is deployed.

Once the first timer has started, the system checks to see it has expired at decision block 132. If the timer has not yet expired, and the operator is determined to again be actively present, e.g., by having engaged the joystick trigger again, at decision block 134, the collection of leaves at step 136 is allowed to continue unchanged. At that point the system then awaits a determination that the operator is again not actively present, e.g., operator disengagement of the joystick trigger or a lock of user input, to start the operation again at step 126.

If, however, the operator is still not actively present, e.g., has not engaged the joystick trigger and/or not provided user input, at decision block 134 and the first timer is determined to have expired at decision block 132, the system then locks the control arm 104 at step 138 to prevent further movement thereof. However, leaf collection may still continue with the engine speed maintained at its current level. In embodiments that require the safety interlock to be engaged for movement of the control arm 104 and the collection nozzle 106, operation can be manually adjusted by the operator via the control buttons 114, 116, with the control arm 104 and the collection nozzle 106 locked in their current orientation if the interlock is not engaged.

Once the control arm has been locked at step 138, a second timer is started at block 140. The second timer may be set from 0 to 120 seconds, and is preferably set at 10 seconds, although other periods may be set depending on the operating environment and system particulars. The system then checks to see whether the timer has expired at decision block 142, and during such period determines whether the operator is determined again to be actively present, e.g., has engaged the joystick trigger and/or provided user input, at decision block 144.

If, before the expiration of the second timer the operator is determined again to be actively present, e.g., engaged the joystick trigger again and/or provided user input, then the arm is unlocked at step 146 and the collection of leaves at block 136 with full operator control of the positioning of the control arm and collection nozzle is allowed to continue or resume. If the operator again is determined not to be actively present, e.g., disengages the joystick trigger and/or no longer provides user input, the control method begins again at starting block 126.

However, if the operator has not been determined to be actively present, e.g., engaged the trigger and/or provided user input, before the expiration of the second timer at decision block 142, the system then decreases the engine speed at block 148 to an intermediate level to reduce fuel consumption and noise generation. Such lack of operator active presence may indicate a pause or reduction of leaf collection activity, but at this point is not particularly indicative that the operation has ended.

Once the engine has been slowed down to this intermediate speed, a third timer is then started at block 150. This third timer is preferably set to between 10 and 120 seconds, with the preferred setting at 10 seconds, although other periods may be chosen. The method checks to see whether this third timer has expired at decision block 152, and if not, whether the operator has again become actively present, e.g., has engaged the joystick trigger and/or provided user input, at decision block 154.

If the operator is determined to be actively present, e.g., has engaged the joystick trigger and/or provided user input, prior to the expiration of the third timer, then the engine speed is increased at block 156 to the level stored in block 128, the collection arm is unlocked at step 146, and the collection of leaves is allowed to continue under full operator control at block 136. During such operator-controlled collection, if the operator again is determined not to be actively present, e.g., disengages the joystick trigger and/or ceases providing user input, then the control method begins again at start block 126.

However, if the operator is not determined to be actively present, e.g., does not reengage the trigger and/or provide user input, prior to the expiration of the third timer, then the method of this embodiment determines that the collection activity is no longer taking place. The method then sets the engine speed to a low idle speed at block 158. Additionally, any accessory equipment that is operating, such as the water pump, is turned off at block 160. This provides the most economical mode of operation both in terms of fuel consumption and noise generation, during such periods of inactivity, i.e., between collection sites, while awaiting more debris to be gathered for collection, etc.

The system stays in this economy mode or state until either, the operator shuts down the engine at decision block 162 or is determined to again be actively present, e.g., reengages the joystick trigger and/or provides user input, at decision block 164. If the operator shuts down the engine as determined by decision block 162, then the method ends at end block 168. Alternatively, once the operator is determined to again be actively present, e.g., reengages the trigger and/or provides user input, at decision block 164, then full operator-controlled collection is again enabled. That is, the accessory equipment is turned back on at block 166, the engine speed is increased at block 156 to the level stored in block 128, the control arm is unlocked at block 146, and the collection of the leaves is again allowed to continue at block 136. Such collection under operator control is allowed to continue, until the operator again is determined not to be actively present, e.g., disengages the joystick trigger and/or does not provide any user input, at start block 126.

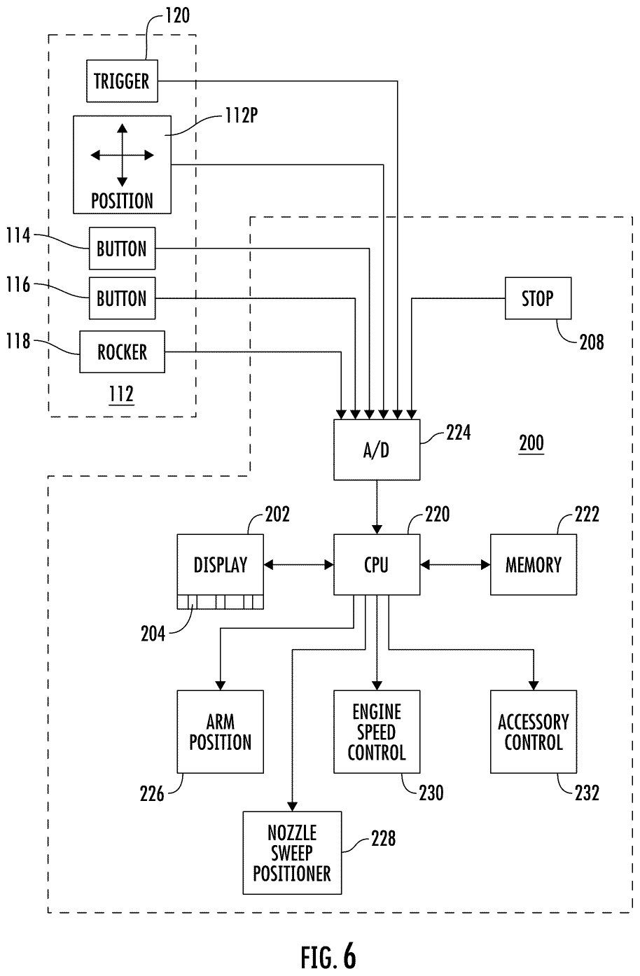

With this understanding of this embodiment of the operational programming control of the debris removal vacuum system 100 firmly in hand, attention is now directed to FIG. 6, which illustrates a block diagram of the controller 200 and the operational control inputs and outputs discussed above. Specifically, the controller 200 includes a processor 220 that utilizes programmed, programmable, and/or storage memory 222 to enable and facilitate operation of the debris removal vacuum system 100. The processor 220 utilizes a display to provide operational and other information to the operator, and may receive operator input therefrom in embodiments that utilize soft or programmable keys 204 and/or touchscreen.

The operator control inputs from the joystick 112, e.g., the trigger 120, the position inputs 112p of the joystick 112, the control buttons 112, 116, the rocker switch 118, as well as other operator inputs, e.g., the emergency stop button 208, are read by the processor 220, directly in one embodiment where the processor 220 is a microcontroller having onboard analog to digital converters or via an A/D 224 in an embodiment wherein the processor 220 is a microprocessor. Based on the programming of the controller 200, which includes the programming discussed above with regard to FIG. 5, and the various operator inputs, the processor 220 commands the arm positioner 226, the nozzle sweep positioner 228, the engine speed controller 230, and the accessory controller 232 to effectuate operation of the various elements of the debris removal vacuum system 100 as discussed above.

It should be noted that while FIG. 6 illustrates the arm positioner 226, the nozzle sweep positioner 228, the engine speed controller 230, and the accessory controller 232 as part of the controller 200, one or more of such controllers may be housed separately, and may contain their own processors and programming for which input from the processor 220 becomes an input thereof. In such cases, the commands from the processor 220 may be communicated via analog signals (via a digital to analog converter, not shown), via a networked communication bus, e.g., a CAN bus, Ethernet, etc., or wirelessly as is known in the art using appropriate communication circuitry.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A debris removal vacuum system, comprising:
an engine operably coupled to drive a fan to generate a vacuum force;
at least one of a safety interlock or a user interface; and
a controller operably connected to the at least one of the safety interlock or the user interface;
wherein the controller is configured to determine whether an operator is actively present based on the at least one of the safety interlock or the user interface; and
wherein the controller is configured to store an operating speed of the engine when controller determines the operator is not actively present; and
wherein the controller is further configured to begin an EcoMode timer of a predetermined duration when controller determines the operator is not actively present during which the controller will maintain the operating speed of the engine, and after which the controller will decrease the speed of the engine to an intermediate speed.

2. The debris removal vacuum system of claim 1, further comprising:
a control arm;
a collection hose carried by the control arm and having a nozzle inlet configured to collect debris under the vacuum force generated by the fan;
wherein the user interface configured to be manipulated by an operator to position the control arm and the collection hose carried thereby and to at least one of increase or decrease a speed of the engine to at least one of increase or decrease the vacuum force generated by the fan driven thereby; and
wherein the controller operably connected to the user interface to receive a first user input from the user interface to position the control arm and the collection hose carried thereby, at least a second user input from the user interface to at least one of increase or decrease the vacuum force generated by the fan driven by the engine, the controller being configured to effectuate positioning of the control arm and the collection hose carried thereby in accordance with the first user input when the safety interlock engaged signal is received, and to effectuate at least one of increasing or decreasing the vacuum force generated by the fan driven by the engine in accordance with at least the second user input; and
wherein the controller is further configured to begin a safety timer of a predetermined safety duration when controller determines the operator is not actively present during which the controller will continue to effectuate positioning of the control arm and the collection hose carried thereby in accordance with the first user input, and after which the controller will no longer effectuate positioning of the control arm and the collection hose carried thereby regardless of the first user input.

3. The debris removal vacuum system of claim 2, wherein the controller is further configured to reset the safety timer when controller determines the operator is actively present.

4. The debris removal vacuum system of claim 3, wherein the controller determines the operator is actively present when at least one of the safety interlock signal indicates the safety interlock has been reengaged during the predetermined safety duration or the operator manipulates the user interface.

5. The debris removal vacuum system of claim 2, wherein the controller is further configured to begin the EcoMode timer after expiration of the predetermined safety duration during which the controller will maintain the operating speed of the engine, and after which the controller will decrease the speed of the engine to an intermediate speed.

6. The debris removal vacuum system of claim 5, wherein the controller is further configured to reset the EcoMode timer when controller determines the operator is actively present when at least one of the safety interlock signal indicates the safety interlock has been reengaged or the operator manipulates the user interface during the predetermined duration and to effectuate positioning of the control arm and the collection hose carried thereby in accordance with the first user input.

7. The debris removal vacuum system of claim 1, wherein the controller is further configured to reset the EcoMode timer when at least one of the safety interlock signal indicates the safety interlock has been reengaged or the operator manipulates the user interface during the predetermined duration.

8. The debris removal vacuum system of claim 1, wherein the controller is further configured to begin a second EcoMode timer of a predetermined second EcoMode duration after expiration of the predetermined duration during which the controller will maintain the intermediate speed of the engine, and after which the controller will decrease the speed of the engine to a low idle speed.

9. The debris removal vacuum system of claim 8, wherein the controller is further configured to reset the second EcoMode timer when at least one of the safety interlock signal indicates the safety interlock has been reengaged or the operator manipulates the user interface during the predetermined second EcoMode duration and to increase the engine speed to the operating speed.

10. The debris removal vacuum system of claim 8, wherein the controller is further configured to turn off an accessory after the third duration.

11. The debris removal vacuum system of claim 10, wherein the controller is further configured to turn the accessory back on when at least one of the safety interlock signal indicates the safety interlock has been reengaged or the operator manipulates the user interface and to increase the engine speed to the operating speed.

12. The debris removal vacuum system of claim 2, wherein the user interface is a joystick.

13. The debris removal vacuum system of claim 12, wherein the safety interlock is a trigger integrated into the joystick.

14. The debris removal vacuum system of claim 12, wherein the safety interlock utilizes capacitive touch integrated into the joystick to indicate user grip of the joystick.

15. The debris removal vacuum system of claim 12, wherein the joystick is configured to be positioned in at least two axes by an operator to generate the first user input, and wherein the joystick includes at least one button to generate the second user input.

16. The debris removal vacuum system of claim 15, wherein the joystick includes a second button to generate a third user input, and wherein the controller is programmed to reduce the engine speed upon receipt of the second user input and to increase the engine speed upon receipt of the third user input.

17. The debris removal vacuum system of claim 16, wherein the controller is programmed to maintain the engine speed at a current level upon loss of one of the second user input or the third user input.

18. The debris removal vacuum system of claim 16, wherein the controller is programmed to return the engine speed to an operating speed upon loss of one of the second user input or the third user input.

19. The debris removal vacuum system of claim 12, wherein the joystick includes a rocker switch to generate a fourth user input, and wherein the controller is programmed to sweep the nozzle inlet upon receipt of the fourth user input.

20. The debris removal vacuum system of claim 1, wherein the safety interlock is an operator seat switch.

21. A method of controlling a debris removal vacuum system, comprising the steps of:
storing an operating speed of the engine when at least one of a safety interlock has been disengaged or an operator ceases manipulation of a user interface;
beginning an EcoMode timer of a predetermined duration, and
during the predetermined duration
maintaining an operating speed of the engine, and
after the predetermined duration
decreasing the speed of the engine to an intermediate speed.

22. The method of claim 21, further comprising the steps of, during the predetermined duration, resetting the EcoMode timer when at least one of the safety interlock has been reengaged or the operator manipulates the user interface.

23. The method of claim 21, further comprising the steps of, after the predetermined duration, beginning a second EcoMode timer of a second predetermined duration, during the second predetermined duration maintaining the intermediate speed of the engine, and after the second predetermined duration, decreasing the speed of the engine to a low idle speed.

24. The method of claim 23, further comprising the steps of, during the second predetermined duration, resetting the second EcoMode timer when at least one of the safety interlock has been reengaged or the operator manipulates the user interface, and increasing the engine speed to the operating speed.

25. The method of claim 21, further comprising the steps of:
beginning a first safety timer of a first safety duration, and
during the first safety duration,
positioning a collection hose under user control, and
resetting the first safety timer when at least one of the safety interlock has been reengaged or the operator manipulates the user interface,
after the first safety duration,
prohibiting positioning of the collection hose under user control.
